(19) United States
(12) Patent Application Publication
(10) Pub. No.: US 2012/0043420 A1
(43) Pub. Date: Feb. 23, 2012

(54) SKID UNDERCARRIAGE AND A METHOD OF PREVENTING A ROTORCRAFT PROVIDED WITH SUCH AN UNDERCARRIAGE FROM TILTING

(75) Inventor: Pierre Prud'Homme-Lacroix, Vitrolles (FR)

(73) Assignee: EUROCOPTER, Marignane (FR)

(21) Appl. No.: 13/207,018

(22) Filed: Aug. 10, 2011

(30) Foreign Application Priority Data
Aug. 18, 2010 (FR) 10 03392

(51) Int. Cl. B64C 25/52

(52) U.S. Cl. 244/108

(57) ABSTRACT

An undercarriage (1) having a first skid (11) provided with a first longitudinal bearing portion (110) and a second skid (12) provided with a second longitudinal bearing portion (120), the first and second skids (11, 12) being connected together by a front crossbar (8) and by a rear crossbar (2), said first skid (11) including a first front portion (20) extending longitudinally and in elevation from the first longitudinal bearing portion (110), said second skid (12) including a second front portion (30) extending longitudinally and in elevation from the second longitudinal bearing portion (120). The undercarriage includes sliding means (15) provided with first and second additional surfaces (41, 42), said first additional surface (41) being fastened under a first contact zone (51) covering at least part of said first front portion (20), and said second additional surface (42) being fastened under a second contact zone (52) covering at least part of said second front portion (30).

### CROSS REFERENCE TO RELATED APPLICATIONS

This application claims the benefit of FR 10 03392 filed on Aug. 18, 2010, the disclosure of which is incorporated in its entirety by reference herein.

### BACKGROUND OF THE INVENTION

(1) Field of the Invention

The present invention relates to a skid undercarriage for rotorcraft, in particular to a helicopter undercarriage, and to a method of preventing a rotorcraft fitted with such an undercarriage from tilting.

(2) Description of Related Art

Conventionally, a rotorcraft has an undercarriage whereby the rotorcraft stands on the ground. More particularly, such undercarriages include undercarriages known as “skid” undercarriages that have a first bearing skid and a second bearing skid, which skids are designed to make contact with the ground and are disposed on either side of the fuselage of the rotorcraft.

Furthermore, a skid undercarriage is usually provided with first and second crossbars each connecting the first and second skids together.

The first crossbar is referred to as a “rear” crossbar insofar as this first crossbar connects together zones situated at the rear of the first and second skids. Conversely, the second crossbar is said to be a “front” crossbar since the second crossbar connects together zones situated at the front of the first and second longitudinal skids.

The undercarriage is then fastened to the rotorcraft via its front and rear crossbars.

A conventional type of skid undercarriage is known, e.g. as described in document U.S. Pat. No. 2,641,423.

In that conventional type of skid undercarriage, the first skid is provided with a first longitudinal bearing portion, the second skid being provided with a second longitudinal bearing portion. The first longitudinal bearing portion and the second longitudinal bearing portion together define a contact plane for the undercarriage on the ground when the aircraft is standing on the ground.

The first skid and the second skid are connected together by a front crossbar and by a rear crossbar, the front crossbar having a front high portion suitable for fastening to the airframe of the aircraft, the rear crossbar having a rear high portion suitable for fastening to said airframe. Under such circumstances, the front high portion and the rear high portion together define a fastening plane for fastening the undercarriage to the airframe of the aircraft.

In addition, the first skid has a first front portion extending longitudinally and in elevation from the first longitudinal bearing portion so as to approach the fastening plane, and the second skid has a second front portion extending longitudinally and in elevation from the second longitudinal bearing portion so as to approach the fastening plane.

In one type of skid undercarriage, the front portions are of curved shape.

Furthermore, it should be observed that the first and second longitudinal portions of the skids may be provided with wear plates, like the plates securely connected to the skids described in documents U.S. Pat. No. 4,544,116, U.S. Pat. No. 5,358,201, and U.S. Pat. No. 5,893,532.

Skid undercarriages are commonly used on rotorcraft.

Furthermore, in order to prevent the rotorcraft from sinking into soft ground, an anti-sinking device is known that is constituted by an additional surface arranged at the rear of the first and second skids, close to the rear ends of the first and second longitudinal bearing portions.

For example, one such anti-sinking device is known under the name “BEARPAW”.

As commonly understood, with a skid undercarriage, whatever its type, a helicopter landing with any horizontal speed is subjected, on making contact with the ground, to torque that is exerted by a friction reaction.

If the torque is greater than the torque generated by any reactions of the rotor and by inertial effects, then the helicopter can tilt forwards (nose down), and then possibly also sideways.

In a normal landing procedure, the pilot must minimize friction effects in order to keep the aircraft stable. Nevertheless, if the piloting procedure is not properly executed, then the front portions of the skids may be subjected to particularly high levels of pressure on making contact with the ground.

However, in extreme situations, i.e. when landing under conditions that are not covered by the flight manual, for example landing on soft ground usually constituted by earth, grass, or sand, e.g. while traveling at downward and forward speeds greater than authorized speeds, accidents may happen. It can be understood that a pilot who is inexperienced, and/or not paying attention, and/or being trained, e.g. flying outside the speed situations as recommended in the flight manual or encountering terrain of unexpected quality, runs the risk of reducing nose-down stability margins, which might in turn lead to an accident.

A rotorcraft manufacturer needs to demonstrate compliance with certification regulations in order to obtain flight authorization. Such certification regulations define the conditions in which landing needs to be possible. Thus, an aircraft is designed to satisfy such certification regulations.

Nevertheless, if landing takes place while sliding at a significant forward speed not specified in the flight manual, e.g. as a result of the pilot performing auto-rotation during training, then the stability margins are smaller and it can happen that the rotorcraft tilts forwards.

### SUMMARY OF THE INVENTION

An object of the present invention is thus to provide an undercarriage that is surprisingly capable of at least limiting the risk of the rotorcraft tilting during a landing performed outside the recommended landing conditions, in order to minimize any risk of accident during a training flight by a trainee pilot.

According to the invention, an undercarriage is provided with a first skid having a first longitudinal bearing portion and a second skid having a second longitudinal bearing portion, the first longitudinal bearing portion and the second longitudinal bearing portion together defining a support plane on ground, the first skid and the second skid being connected together by a front crossbar and a rear crossbar, the front crossbar having a front high portion suitable for fastening to an airframe of the aircraft, and the rear crossbar having a rear high portion suitable for fastening to said airframe, said front high portion and the rear high portion together defining a fastening plane, said first skid having a first front portion extending longitudinally and in elevation from the first longitudinal bearing portion so as to approach the fastening plane, said second skid including a second front portion extending longitudinally and in elevation from the second longitudinal bearing portion so as to approach the fastening plane. Under such circumstances, the front portion of each skid extends its longitudinal bearing portion upwards and forwards from the support plane.

Such a skid undercarriage is remarkable in that it includes sliding means provided with first and second additional surfaces, the first additional surface being fastened under a first contact zone covering the first front portion at least in part, the second additional surface being fastened under a second contact zone covering the second front portion at least in part.

The invention then makes it possible in extremely surprising manner to limit the risk of tilting by arranging sliding means under the contact zones of the skids facing the ground.

Before the invention, it was logical to think that an accident was unfortunately a logical and inevitable consequence of a landing performed poorly or under conditions that are particularly dangerous and not specified in the flight manual.

However the Applicant has observed that during such a landing, a skid undercarriage tends to deform.

More precisely, a landing takes place with a vertical speed that is sufficient to bend the longitudinal bearing portions of the skids.

Thus, even if the skids are indeed parallel to the ground before making contact with soft ground, the bending causes the undercarriage to sink in, and more particularly causes the first and second front portions of the first and second skids respectively to sink in.

This situation is not problematic on hard ground such as concrete since the rotorcraft slides on the ground if landing with any significant forward speed.

In contrast, on soft ground, the first and second front portions sink into the ground. This impedes any sliding of the rotorcraft, which then runs the risk of tilting forwards and then sideways if the rotor blades should strike the ground, for example. Furthermore, by sinking into the ground, the front portions run the risk of striking an obstacle that could cause the rotorcraft to tilt forwards.

The invention makes it possible at least to limit or even to avoid accidents during sliding landings on soft ground by minimizing or even preventing the first and second front portions sinking into said soft ground.

It should be observed that hard ground may be represented in a finite-element model using elements that present infinite stiffness, whereas on the contrary soft ground is represented by elements presenting stiffness that is not infinite.

More precisely, in order to grasp the problem thoroughly, it is appropriate to define the stiffness of soft ground in non-constant manner. Thus, the stiffness of soft ground may have a first value that is large at the moment of contact between the undercarriage and the ground, and subsequently a second value that is small as a result of said contact giving rise to behavior that is pseudo-plastic.

By going against existing prejudices in order to determine in novel and innovative manner the problem that needs to be solved in order to minimize the risk of accident during landing taking place under non-standard conditions, in particular by quantifying soft ground and then finding a solution to the problem, which solution is simple to implement and contrary to the prior art, the Applicant has thus managed to achieve the specified objects.

Contrary to what used to be thought before the invention, it becomes possible to land a rotorcraft having a skid undercarriage with risks that are limited when sliding on soft ground, while not imposing on the pilot an excessive workload and while not requiring great experience either.

The first and second additional surfaces minimize or prevent the front portions of the skids sinking in while landing on soft ground with significant forward speed. Consequently, the rotorcraft does not tilt forwards in unwanted manner.

This solution is easily implemented on all existing skid undercarriages without major modification and independently of the embodiment of the skid undercarriage. Whatever the configuration of the undercarriage and independently of the arrangement of the front and rear crossbars relative to the first and second skids, the invention enables the problem as posed to be solved.

The invention may also present one or more of the following optional characteristics.

For example, it is possible to provide for each front portion to rise above the support plane while being optionally oriented towards the longitudinal plane of symmetry of the undercarriage.

In addition, at least one additional surface may be curved so as to be suitable for being pressed against an associated contact zone.

Thus, the first and/or the second additional surface is/are optionally curved so as to be pressed respectively against the associated first contact zone and/or second contact zone.

Because of their particular shape, the first and second additional surfaces thus do not run any risk of turning respectively about the first and second contact zones. The first and second additional surfaces are thus continuously in an appropriate position.

In addition, it is possible to envisage at least one additional surface being shaped to match the associated contact zone, the first and/or second additional surfaces being shaped to match the associated first and/or second contact zones.

By optimizing the arrangement of the additional surfaces, the impact of said additional surfaces on the drag of the rotorcraft is minimized.

In addition, at least one additional surface, the first and/or second additional surface, is a curved plane plate, thereby minimizing production costs.

In a first variant, at least one additional surface, the first and/or second additional surface, is of section that is rectangular in order to facilitate fabrication thereof.

In a second variant, at least one additional surface, the first and/or second additional surface, is of section that is curved.

In a third variant, representing a compromise between the first and second variants, at least one additional surface, the first and/or second additional surface, is of section that is trapezoidal.

It can be understood that the first and second additional surfaces may be made using different variants. Nevertheless, it appears advantageous to fit additional surfaces of the same variant on any given undercarriage.

In order to facilitate sliding, each longitudinal bearing portion has a tube of given diameter, and at least one additional surface, the first and/or second additional surface, has a contact strip that possesses a contact width with the ground having a value that lies in the range 120% to 140% of said given diameter, in order to be effective while limiting the aerodynamic drag of the additional surface.

In surprising manner, this range thus enables said additional surface to avoid unduly harming the aerodynamic performance of the undercarriage, while not diminishing its performance in sliding.

Similarly, at least one additional surface is arranged under the associated front portion over a minimum given length suitable for guaranteeing contact between said additional surface and the ground at a maximum authorized angle of inclination of said rotorcraft.

Thus, the first additional surface extends under the first front portion over a first given length from the first longitudinal bearing portion of the first skid. Similarly, the second additional surface extends under the second front portion over a first given length from the second longitudinal bearing portion of the second skid.

More precisely, the rotorcraft may in fact tilt forwards up to a given maximum angle of inclination, the fuselage or the blades of the rotorcraft coming into contact with the ground only beyond said maximum angle of inclination.

The first given length is then determined by considering that the additional surface needs to be in contact with the ground for a forward angle of inclination of the rotorcraft extending up to said maximum angle of inclination, which is determined geometrically in the usual way by the person skilled in the art.

Alternatively, at least one additional surface is arranged under the associated front portion, over a second given length that is longer than said minimum first length and that is suitable for guaranteeing contact between said additional surface and the ground for a maximum authorized angle of inclination of said rotorcraft.

Thus, the additional surface is capable of deflecting an obstacle independently of the forward angle of inclination of the rotorcraft.

Optionally, the first contact zone also covers a first front contact surface of the first skid over a predetermined length, and/or the second contact zone also covers a second front contact surface of the second skid over a predetermined length.

In the extreme, the additional surface may cover the entire longitudinal bearing portion of the skid. Nevertheless, the person skilled in the art seeking to implement this variant will determine the predetermined length by making a compromise between unwanted increase in weight due to the additional surface and the anti-tilting performance of the additional surface.

It should be observed that the skids of a conventional undercarriage generally include wear plates in order to protect them. In the present circumstances, the additional surfaces may naturally replace the wear plates, thereby compensating the extra weight generated by the additional surfaces.

Furthermore, at least one additional surface may be fastened to the associated front portion using friction attachment means suitable for not altering the stiffnesses of the working elements of the undercarriage.

Furthermore, said additional surface may also be fastened to the associated skid using said attachment means.

The first additional surface is then optionally fastened to the associated first front portion and possibly to the first longitudinal bearing portion of the associated skid using friction attachment means, possibly comprising one or more collars secured to the first additional surface and suitable for not altering the stiffnesses of the working elements of the undercarriage. Similarly, the second additional surface is optionally fastened to the associated second front portion and possibly to the second longitudinal bearing portion of the associated second skid using friction attachment means, optionally including one or more collars secured to the second additional surface and suitable for not altering the stiffnesses of the working elements of the undercarriage.

Under such conditions, the first and second additional surfaces do not modify the performance of the skid undercarriage. There is therefore no need to perform additional certification testing or calculations, in particular since the vertical and horizontal stiffnesses and the resonant frequencies of the rotorcraft on its undercarriage remain unchanged.

For example, a flexible connection member may be placed between at least one additional surface and the associated contact zone, each flexible connection member comprising for example a material selected from the group of elastomers.

Thus, a flexible connection member is arranged between the first additional surface and the first contact zone, and also between the attachment means of the first additional surface and said first contact zone.

Similarly, a flexible connection member is arranged between the second additional surface and the second contact zone, and also between the attachment means of the second additional surface and said second contact zone.

Consequently, because of the flexible interface, there is no rigid connection between each additional surface and the first and second longitudinal bearing portions, and also between each additional surface and the front portions of the skids.

The present invention also provides a method of at least limiting or even preventing the risk of a rotorcraft tilting forwards or to the side while landing, said rotorcraft having an undercarriage provided with a first skid having a first longitudinal bearing portion and a second skid having a second longitudinal bearing portion, the first longitudinal bearing portion and the second longitudinal bearing portion together defining a support plane on ground, the first skid and the second skid being connected together by a front crossbar and a rear crossbar, the front crossbar having a front high portion suitable for fastening to an airframe of the aircraft, and the rear crossbar having a rear high portion suitable for fastening to said airframe, said front high portion and the rear high portion together defining a fastening plane, said first skid having a first front portion extending longitudinally and in elevation from the first longitudinal bearing portion so as to approach the fastening plane, said second skid including a second front portion extending longitudinally and in elevation from the second longitudinal bearing portion so as to approach the fastening plane.

During the method, sliding means provided with first and second additional surfaces are arranged respectively under a first contact zone covering at least part of the first front portion and under a second contact zone covering at least part of the second front portion.

Independently of the skill of the rotorcraft pilot and of landing conditions, the rotorcraft then does not run the risk of tilting forwards or to the side.

Optionally, it should be observed that said first and second additional surface portions are attached respectively to a first assembly comprising at least said first front portion and to a second assembly comprising at least said second front portion, more precisely under the first and second contact zones of said first and second assemblies facing the ground when the rotorcraft is standing on the ground.

In addition to the first front portion, the first assembly may include the first contact surface of the first skid. Similarly, in addition to the second front portion, the second assembly may include the second contact surface of the second skid.

Furthermore, a resilient connection member may be arranged between at least one additional surface and the associated contact zone.

### BRIEF DESCRIPTION OF THE DRAWINGS

The invention and its advantages appear in greater detail from the following description of embodiments given by way of illustration and with reference to the accompanying figures, in which:

FIG. 1 is a diagrammatic isometric view of an undercarriage of the invention;

FIG. 2 is a side view showing a first length of an additional surface;

FIG. 3 is a side view of an additional surface of the invention arranged on an undercarriage;

FIG. 4 is a section of an additional surface in a first variant;

FIG. 5 is a section of an additional surface in a second variant; and

FIG. 6 is a section of an additional surface in a third variant;

FIG. 7 is a section of an additional surface in a fourth variant.

Elements present in more than one of the figures are given the same references in each of them.

### DETAILED DESCRIPTION OF THE PREFERRED EMBODIMENTS

Three mutually orthogonal directions X, Y, and Z are shown in Figures.

The direction X is said to be longitudinal insofar as it extends in the longitudinal direction of the rotorcraft fitted with the invention, also referred to as the roll axis. The term “length” relates to a dimension along this longitudinal direction X.

Another direction Y is said to be transverse insofar as it extends in the transverse direction of the rotorcraft fitted with the invention, also known as the pitching axis. The term “width” relates to a dimension in this transverse direction.

Finally, a third direction Z is said to be in elevation insofar as it extends in the vertical direction relative to the rotorcraft fitted with the invention, and is also known as the yaw axis.

It should be observed that the longitudinal and transverse directions X and Y define an XY plane referred to as the horizontal plane, whereas the longitudinal and elevation directions X and Z define an XZ plane referred to as a vertical plane.

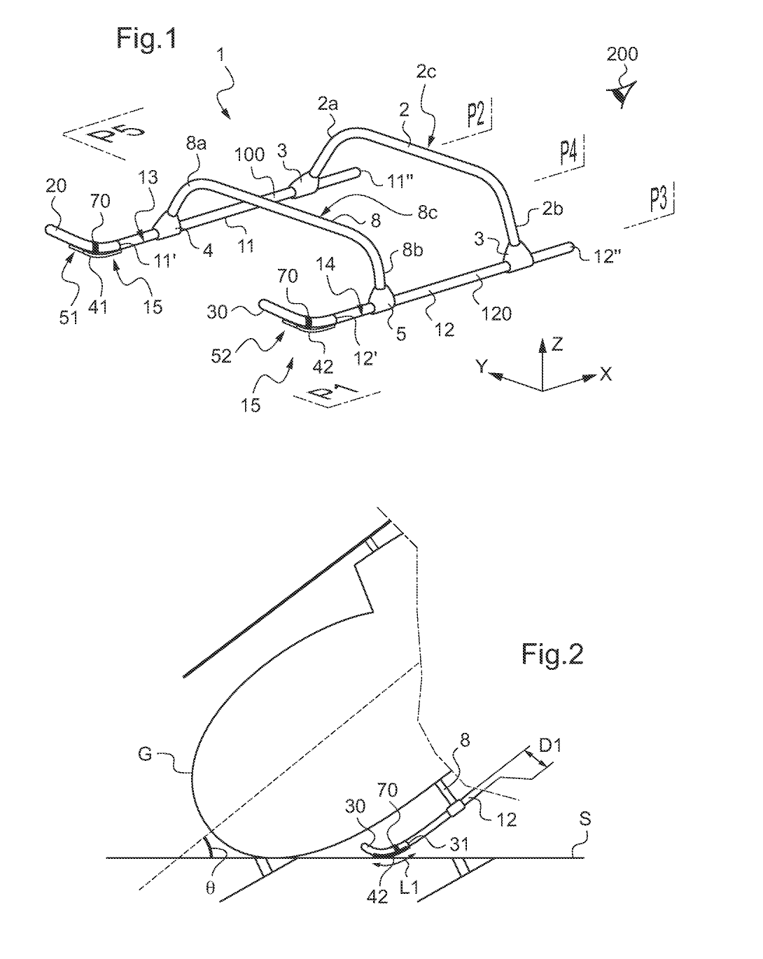

FIG. 1 is a diagrammatic isometric view of an undercarriage rotorcraft 1 of the invention.

This undercarriage 1 comprises first and second skids 11 and 12 for coming into contact with the ground when the rotorcraft, e.g. a helicopter, is standing on said ground.

These first and second skids 11 and 12 are located respectively on the right and the left of the fuselage of the rotorcraft, where “right” and “left” are defined relative to an observer 200 looking from the rear of the rotorcraft.

The first skid comprises a first longitudinal bearing portion 110 extending longitudinally from a first front end 11′ towards a first rear end 11″ going from the front towards the rear of the rotorcraft. Similarly, the second skid has a second longitudinal bearing portion 120 extending longitudinally from a second front end 12′ towards a second rear end 12″.

Furthermore, the first and second skids 11 and 12 are connected to a rear crossbar 2. First and second downward branches 2a and 2b of this rear crossbar 2 are fastened to the first and second skids 11 and 12, e.g. via first sleeves 3.

A rear high portion 2c of the rear crossbar may then be fastened to the rotorcraft via at least one fastening.

The undercarriage 1 also includes a front crossbar 8 for connecting the first and second skids together.

The front crossbar 8 possesses firstly a first downward branch 8a fastened to the first skid 11 via a second sleeve 4, for example, and also a second downward branch 8b fastened to the second skid 12, via a second sleeve 5, for example. A front high portion 8c of the front crossbar may then be fastened to the rotorcraft via at least one fastening, the front high portion 8c being arranged between the first and second downward branches 8a, 8b.

The rear high portion 2c and the front high portion 8c lie in a plane referred to for convenience as the “fastening plane P5”.

The first longitudinal bearing portion 110 and the second longitudinal bearing portion 120 together define a support plane P1 on which the undercarriage 1 rests on the ground.

In addition, the first and second skids 11 and include respectively a first front portion 20 and a second front portion 30 extending respectively the first and second longitudinal bearing portions 110, and 120.

The first front portion 20 is then secured to the first front end 11′ of the first longitudinal bearing portion 110. This first front portion 20 extends forwards above the support plane P1, parallel to the horizontal plane XY and in contact with the ground when the rotorcraft is standing on the ground, approaching the fastening plane P5 and going away from the first longitudinal bearing portion 110.

More precisely, the first front portion 20 rises above the support plane P1 and in parallel to the longitudinal plane of symmetry P4 of the rotorcraft.

Thus, this first front portion 20 is contained in the elevation plane P2 containing the first skid 11, which elevation plane P2 may be parallel to the vertical plane XZ and to the longitudinal plane of symmetry P4 of the rotorcraft.

The second front portion 30 is then secured to the second front end 12′ of the second longitudinal bearing portion 120. This second front portion 30 extends forwards above the support plane P1, parallel to the horizontal plane XY and in contact with the ground when the rotorcraft is standing on the ground, extending towards the fastening plane P5 and away from the second longitudinal bearing portion 120.

More precisely, the second front portion 30 rises above the contact plane P1 and in parallel to the longitudinal plane of symmetry P4 of the rotorcraft.

Thus, this second front portion 30 is contained in the elevation plane P3 containing the second skid 12, this elevation plane P3 possibly being parallel to the vertical plane XZ and to the longitudinal plane of symmetry P4 of the rotorcraft.

The undercarriage also includes sliding means 15 acting as an anti-tilting device, provided with first and second additional surfaces 41 and 42 to prevent the rotorcraft tilting forwards or sideways while landing at a non-zero speed of advance on soft ground.

The first additional surface 41 is then arranged under a first contact surface 51 covering at least part of the first front portion 20.

Similarly, the second additional surface 42 is arranged under a second contact surface 52 covering at least part of the second front portion 30.

Thus, each contact surface 51 and 52 faces the ground, or is indeed partially in contact with the ground when the rotorcraft is standing on the ground.

Consequently, when the rotorcraft slides on the ground, the first and second additional surfaces 41 and are in contact with the ground. These first and second additional surfaces 41 and 42 limit or indeed prevent the undercarriage 1 sinking into the ground and consequently prevent any significant forward tilting or sideways tilting of the rotorcraft that might otherwise damage the rotorcraft.

Finally, FIG. 1 shows that the first and second skids are advantageously symmetrical relative to the plane of symmetry P4.

FIG. 2 is a side view of a rotorcraft provided with an embodiment of the invention.

In the embodiment shown, each additional surface extends solely and partially under the associated front portion, being fastened to said front portion.

More precisely, FIG. 2 shows the second additional surface 42 that extends partially under the second front portion 30 over a first given length L1.

It can be seen that the second additional surface 42 remains in contact with the ground S until the rotorcraft G reaches an angle of inclination θ equal to a maximum angle of inclination, up to which the fuselage or the blades of the rotorcraft do not run any risk of coming into collision with the ground.

It should be observed that each additional surface may in particular be fastened to the second front portion 30 by using attachment means 70.

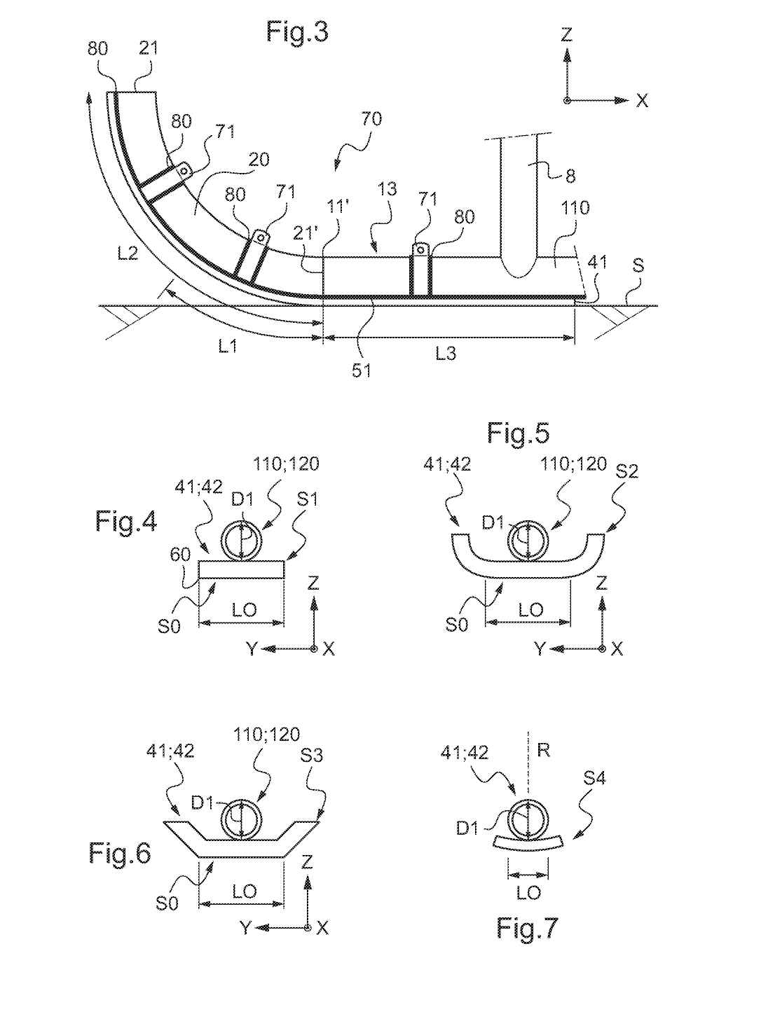

FIG. 3 is a side view of an additional surface of the invention arranged on an undercarriage, more precisely the first additional surface 41 that rests in part on ground S.

In the embodiment shown in FIG. 3, each additional surface does not extend solely under the associated front portion over said given first length L1.

This first additional surface 41 is a curved plane plate arranged under the first contact zone 51, while being fastened to the first longitudinal bearing portion 110 and to the first front portion 20 of the first skid 11 by connection means 70. The connection means 70 comprise three collars 71 secured to the first additional surface, a first collar surrounding the first longitudinal bearing portion 110 of the first skid 11 at the first contact surface 13, while a second collar and a third collar surround the first front portion 20.

A flexible connection member 80, e.g. a layer of material selected from the group of elastomers, is then advantageously arranged between the first additional surface 41 and the first contact surface 13. Similarly, a flexible connection member 80 is disposed between each collar 71 of the attachment means 70 and the element surrounded by the collar 71.

Thus, the first additional surface 41 is connected to the first skid 11 by a flexible connection member so as to avoid degrading the performance of the undercarriage 1.

Because of the flexible connection member, the first additional surface 41 runs no risk of modifying the stiffnesses of the working elements of the undercarriage.

In addition, the first additional surface 41 is curved so as to follow the profile of the first contact surface 13.

It can be seen that the first additional surface 41 then cannot turn about the first skid because of interfering shapes.

Finally, the first additional surface 41 extends under the first contact surface 13 of the first longitudinal bearing portion 110 from its first front end 11′ and thus towards its first rear end 11″, over a predetermined length L3.

Optionally, the additional surface 41 may extend along the skid in full, the predetermined length L3 then extending from the first front end of the skid towards the first rear end of the skid.

In contrast, the first additional surface 41 may extend under the first front portion 20 from the connection zone 21′ between the first front portion 20 and the first front end 11′ of the first longitudinal bearing portion 110 over a second given length L2 that is longer than said above-mentioned first given length L1 in order to enable obstacles to be deflected, regardless of the forward angle of inclination θ of the rotorcraft.

Optionally, the front portion is shaped like the front end of a ski and the additional surface 41 may extend along all of the shaped front portion, the second given length L2 then extending from the zone 21′ where the shaped front portion is connected to the associated longitudinal bearing portion towards the free end 21 of said shaped front portion.

It can be readily understood that the second additional surface 42 may be symmetrical to the first additional surface 41 about the plane of symmetry P4, so the comments above when describing FIG. 3 apply to it likewise.

FIG. 4 is a section through an additional surface in a first variant.

In this first variant, the additional surface is a plate, being curved to follow the shape of the associated contact zone, and having a section S1 that is rectangular.

In contrast, with reference to the second variant shown in FIG. 5, every section of the additional surface may be a section S2 that is curved so as to present its concave side facing towards the contact zone of the skid.

FIG. 6 shows a section S3 of an additional surface in a third variant, in which the section is trapezoidal.

In another variant in FIG. 7, it is possible to shape an additional surface to match the associated contact zone.

Finally, independently of the variant that is selected, it is advantageous for the contact strip S0 that is to rest on the ground S to have a contact width L0 lying in the range 120% to 140% of the diameter D1 of the tube of the associated longitudinal bearing portion 110, 120.

Naturally, the present invention may be subjected to numerous variations as to its implementation. Although several embodiments are described, it will readily be understood that it is not conceivable to identify exhaustively all possible embodiments. It is naturally possible to envisage replacing any of the means described by equivalent means without going beyond the ambit of the present invention.

For example, FIG. 1 shows a front crossbar that is practically orthogonal to the first and second skids and fastened to the first and second longitudinal bearing portions of said first and second skids. Nevertheless, any undercarriage configuration could be envisaged, for example using a front crossbar that is inclined and/or fastened to the front portion.

What is claimed is:

1. An undercarriage provided with a first skid having a first longitudinal bearing portion and a second skid having a second longitudinal bearing portion, the first longitudinal bearing portion and the second longitudinal bearing portion together defining a support plane (P1) on ground (S), the first skid and the second skid being connected together by a front crossbar and a rear crossbar, the front crossbar having a front high portion suitable for fastening to an airframe of the aircraft, and the rear crossbar having a rear high portion suitable for fastening to said airframe, said front high portion and the rear high portion together defining a fastening plane (P5), said first skid having a first front portion extending longitudinally and in elevation from the first longitudinal bearing portion so as to approach the fastening plane (P5), said second skid including a second front portion extending longitudinally and in elevation from the second longitudinal bearing portion so as to approach the fastening plane (P5),
wherein the undercarriage includes sliding means provided with first and second additional surfaces, said first additional surface being fastened under a first contact zone covering said first front portion at least in part, said second additional surface being fastened under a second contact zone covering said second front portion at least in part,
and in that each longitudinal bearing portion has a tube of given diameter (D1), and at least one additional surface has a contact strip (S0) that possesses a contact width (L0) with the ground having a value that lies in the range 120% to 140% of said diameter.

2. An undercarriage according to claim 1, wherein at least one additional surface is curved so as to be capable of being placed under the associated contact zone.

3. An undercarriage according to claim 1, wherein at least one additional surface is shaped to match the associated contact zone.

4. An undercarriage according to claim 1, wherein said first contact zone also covers a first front contact surface of the first longitudinal bearing portion over a predetermined length (L3), and/or in that said second contact zone (52) also covers a second front contact surface of the second longitudinal bearing portion over a predetermined length (L3).

5. An undercarriage according to claim 1, wherein at least one additional surface is fastened to the associated front portion using friction attachment means suitable for not altering the stiffnesses of the working elements of the undercarriage.

6. An undercarriage according to claim 1, wherein at least one additional surface is fastened to the associated front portion and to the associated longitudinal bearing portion using friction attachment means suitable for not altering the stiffnesses of the working elements of the undercarriage.

7. An undercarriage according to claim 1, wherein a resilient connection member is arranged between at least one additional surface and the associated contact zone.

8. A method of at least limiting or even preventing the risk of a rotorcraft tilting forwards or to the side while landing, said rotorcraft having an undercarriage provided with a first skid having a first longitudinal bearing portion and a second skid having a second longitudinal bearing portion, the first longitudinal bearing portion and the second longitudinal bearing portion together defining a support plane (P1) on ground (S), the first skid and the second skid being connected together by a front crossbar and a rear crossbar, the front crossbar having a front high portion suitable for fastening to an airframe of the aircraft, and the rear crossbar having a rear high portion suitable for fastening to said airframe, said front high portion and the rear high portion together defining a fastening plane (P5), said first skid having a first front portion extending longitudinally and in elevation from the first longitudinal bearing portion so as to approach the fastening plane (P5), said second skid including a second front portion extending longitudinally and in elevation from the second longitudinal bearing portion so as to approach the fastening plane (P5), wherein sliding means provided with first and second additional surfaces are arranged respectively under a first contact zone covering at least part of said first front portion and under a second contact zone covering at least part of said second front portion.

9. A method according to claim 8, wherein said first and second additional surface portions are attached respectively to a first assembly comprising at least said first front portion and to a second assembly comprising at least said second front portion.

10. A method according to claim 8, wherein a flexible connection member is placed between at least one additional surface and the associated contact zone.
